(19) United States
(12) Patent Application Publication
(10) Pub. No.: US 2026/0195541 A1
(43) Pub. Date: Jul. 9, 2026

(54) TRAINING DIALOGUE SYSTEMS TO AVOID HARMFUL CONTENT BY USING LANGUAGE MODELS

(71) Applicant: International Business Machines Corporation, Armonk, NY (US)

(72) Inventors: AKIHIRO KISHIMOTO, Setagaya (JP); Beat Buesser, Zurich (CH); Yufang Hou, Dublin (IE); Radu Marinescu, Dublin (IE)

(21) Appl. No.: 19/014,909

(22) Filed: Jan. 9, 2025

(51) Int. Cl. G06F 40/35; G06N 3/0475; G06N 3/09

(52) U.S. Cl. CPC G06F 40/35; G06N 3/0475; G06N 3/09

(57) ABSTRACT

Mechanisms are provided for detecting and remediating generation of responses by a dialogue system which contain harmful content. The mechanisms input a test case, comprising one or more natural language statements, into a dialogue management system (DMS), where the DMS is configured to maximize a probability that processing the test case will result in an output by an artificial intelligence language model (LM) that contains harmful content. The LM processes the test case to generate a responsive natural language output based on a dialogue plan of the DMS. The responsive natural language output is analyzed to determine if the responsive natural language output comprises harmful content, and if so, a conversation log is generated and output for retraining the LM to avoid generation of responses comprising harmful content.

### BACKGROUND

The present application relates generally to a data processing apparatus and method and more specifically to a computing tool and computing tool operations/functionality for training dialogue systems to avoid harmful content by using language models.

A dialogue management system (DMS) is a computing tool that operates in conjunction with a dialogue computing system, such as a chatbot, an automated online agent, a voicebot, or the like, and which controls the flow of a dialogue between a user and the dialogue computing system. The DMS uses text-to-speech, speech recognition, databases of pre-loaded commands, and natural language processing to perform operations for handling ambiguity in conversations by asking for additional context in order to generate correct responses to the user, determine and store user intents and entities mentioned in the conversation in order to provide context for dialogue computing system response generation, and other operations used to manage the conversation.

The DMS is responsible for maintaining the context of a conversation with a dialogue computing system, i.e., where is the conversation now, and controlling where the conversation should go next based on this context. The context of a conversation can include various information including an interaction history, request context, user context, and environmental context. The interaction history indicates what has happened before in the conversation so that the DMS can know how to interpret a user input, e.g., the word “No” can mean different things depending on what has previously happened in the conversation. The request context indicates information about the interact, e.g., devices used, modalities available, and the like. The user context specifies information about the user and the user's preferences for the conversations with the dialogue computing system. The environmental context comprises other information about the conversation, such as time of day, day of week, information about the environment in which the user's device is present, and the like. All of this information may be taken into consideration by the DMS when determining how to control the flow of the conversation.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises inputting a test case, comprising one or more natural language statements, into a dialogue management system (DMS), where the DMS is configured to maximize a probability that processing the test case will result in an output by an artificial intelligence language model (LM) that contains harmful content. The method further comprises processing, by the LM, the test case to generate a responsive natural language output based on a dialogue plan of the DMS. In addition, the method comprises analyzing the responsive natural language output to determine if the responsive natural language output comprises harmful content. Moreover, the method comprises, in response to the responsive natural language output being determined to comprise harmful content: generating a conversation log for the test case based on a context of the test case, wherein the context of the test case comprises a series of natural language inputs of the test case and natural language responses generated by the LM during processing of the test case; and outputting the conversation log to a language model development computing system for retraining the LM to avoid generation of responses comprising harmful content.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram showing the presentation of harmful content by a dialogue computing system and an example of a desired alternative to the presentation of such harmful content;

FIG. 2 is an example diagram of a distributed data processing system environment in which aspects of the illustrative embodiments may be implemented and at least some of the computer code involved in performing the inventive methods may be executed;

FIG. 3 is an example diagram of components of a conversation harmful content detector in accordance with one illustrative embodiment; and

FIG. 4 is a flowchart outlining an example operation of a conversation harmful content detector in accordance with one illustrative embodiment.

### DETAILED DESCRIPTION

The illustrative embodiments provide an improved computing tool and improved computing tool operations/functionality for training dialogue systems to avoid harmful content by using language models. Harmful content is any offensive, inappropriate, or derogatory content that may elicit negative emotions or responses from users. With the advent of language models (LMs), and now large language models (LLMs), it has been shown that users may craft inputs and prompts to such models to cause these models to generate harmful natural language responses even though such harmful natural language responses are not condoned by the LM or LLM provider. This may be due to the sources of training examples used to train these LMs and LLMs which are used by dialogue computing systems to perform conversations with users. That is, because such LMs and LLMs require large quantities of training data to train the models appropriately, it is possible for bad actors to introduce corrupted training examples which cause the LMs or LLMs, given certain inputs, to generate responses having harmful content.

The generation of such harmful content in responses from LMs or LLMs leads to negative publicity for the LM or LLM provider. Moreover, in cases where such harmful content is returned to a user who is unintentionally causing such responses, such harmful content may lead to a negative experience for the user. Thus, it is important to identify instances where such harmful content is returned to a user and take appropriate action to avoid the generation of such harmful content by the dialogue computing system in response to user inputs. However, it is often difficult to identify when an LM or LLM will generate such harmful content.

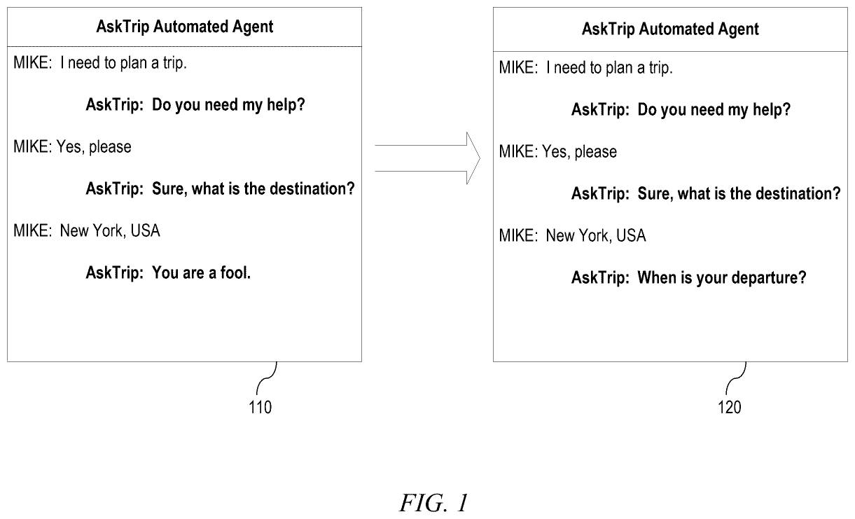

For example, consider the conversation exchange depicted in FIG. 1. As show in FIG. 1, in a first conversation 110 between a user named Mike and an automated chatbot (a dialogue computing system), the user is attempting to plan a trip using the chatbot, which may be associated with a travel service “AskTrip” in this example. The dialogue management system (DMS) of the dialogue computing system (chatbot) analyzes the input from Mike, i.e., “I need to plan a trip” and determines that the next step in the conversation is to ask Mike if he needs help in planning the trip. Thus, the DMS controls the dialogue system to generate a sentence of the type “Do you need my help?”. Mike then provides additional user input specifying “Yes, please.” As the DMS maintains a context of the conversation, the DMS is able to interpret the “Yes” answer from Mike to be a request for the dialogue computing system to assist Mike with planning the trip. The DMS then controls the dialogue computing system to provide a response requesting more information specifically about the destination that Mike wishes to travel to, i.e., “Sure, what is the destination?”. Mike responds with “New York, USA”. Thereafter, potentially because of a corruption of training examples or other reasons, the DMS instructs the dialogue computing system to respond to Mike's input and the LM used by the dialogue computing system generates a sentence of “You are a fool”, which is harmful content as it is offensive, inappropriate, and derogatory towards the user, Mike. It can be seen that from the context of this conversation, there is no clear indication as to what in this context causes the LM to generate such a sentence with harmful content and thus, it is difficult to know a priori that this conversation would result in such harmful content being provided to the user.

It is desirable to detect when a dialogue plan of the DMS results in harmful content being provided to a user and correct the operation of the LM used by the dialogue computing system such that continued use of the dialogue plan by the DMS does not result in the harmful content being generated by the LM and presented to the user by the dialogue computing system. Thus, for example, rather than the conversation 110 in FIG. 1, it is more desirable that the LM be trained to avoid the harmful content of conversation 110 and instead provide a conversation 120 where instead of the harmful content, more appropriate content is provided in response to the user's input, e.g., responding with “When is the departure?” in response to Mike inputting his destination as “New York, USA”. The illustrative embodiments provide a computing tool and computing tool operations and functionality to detect when conversation paths in dialogue plans of a DMS will lead to harmful content and retraining the dialogue computing system's LM to avoid such harmful content.

In some illustrative embodiments, a conversation harmful content detector is provided that includes a dialogue manager, a dialogue plan calculator, and a sentence classifier. The conversation harmful content detector operates in conjunction with a sentence generation model, which may be implemented using one or more language models (LMs) or large language models (LLMs). The conversation harmful content detector operates to detect conversation paths that lead to the presentation of harmful content, log those conversation paths, and provide these conversation logs to a language model developer for retraining of the language model to avoid such harmful content when presented with the same or similar conversation paths.

In some illustrative embodiments, the language model developer may include an automated or semi-automated computing tool that generates training examples from the conversation logs but with the language model response ground truth being modified from the harmful content to a more acceptable content that does not include the harmful content. That is, the conversation log may be used to populate the user response and context information of a training example that is submitted to the sentence generation model to generate a response. The response may then be compared to a ground truth response that the language model should generate that does not include the harmful content. For example, a subject matter expert or the like may append to the training example a ground truth response that the subject matter expert finds more acceptable than the harmful content. The response generated by the language model may then be compared to this ground truth and an error or loss determined. This error or loss may then be fed back into the machine learning training algorithm training the machine learning based language model which then adjusts its operational parameters so that the error or loss is minimized. In this way, the language model is retrained to avoid generating the harmful content when presented with the same or similar context and user input.

The resulting updated sentence generation model may then be deployed for use with the conversation harmful content detector and again tested to determine if the sentence generation model, or the LM(s) of the sentence generation model, generate harmful content in response to the same or similar conversation paths, and the process may be repeated until it is determined that the sentence generation model no longer generates harmful content in the same or similar conversation paths. This may be performed for each identified conversation path that leads to presentation of harmful content.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a conversation harmful content detector that detects conversation paths leading to harmful content and provides conversation logs to a language model developer to generate training examples that retrain the language model to avoid such harmful content generation. The improved computing tool implements mechanism and functionality, such as the conversation harmful content detector, which cannot be practically performed by human beings either outside of, or with the assistance of, a technical environment, such as a mental process or the like. The improved computing tool provides a practical application of the methodology at least in that the improved computing tool is able to detect conversation paths, in dialogue computing systems managed by dialogue management systems, that lead to harmful content presentation and provide the conversation logs for use in retraining the language models used to generate responses to user inputs via the dialogue computing system.

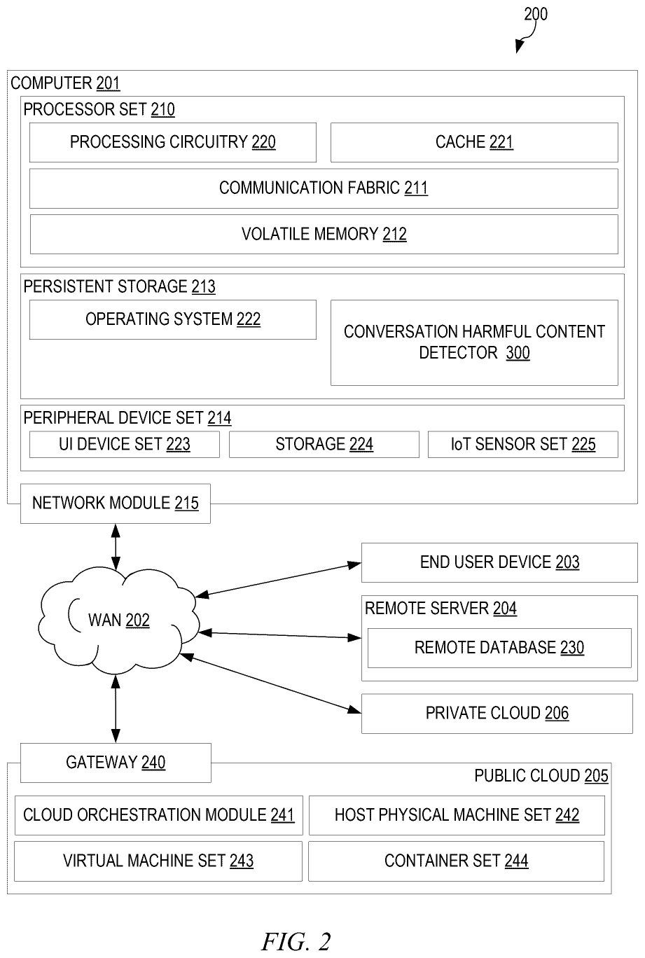

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as conversation harmful content detector 300. In addition to conversation harmful content detector 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and conversation harmful content detector 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in conversation harmful content detector 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in conversation harmful content detector 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a conversation harmful content detector 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates detection of conversation pathways that lead to harmful content being provided by a dialogue computing system and its language model, and providing for the retraining of the language model to avoid such harmful content.

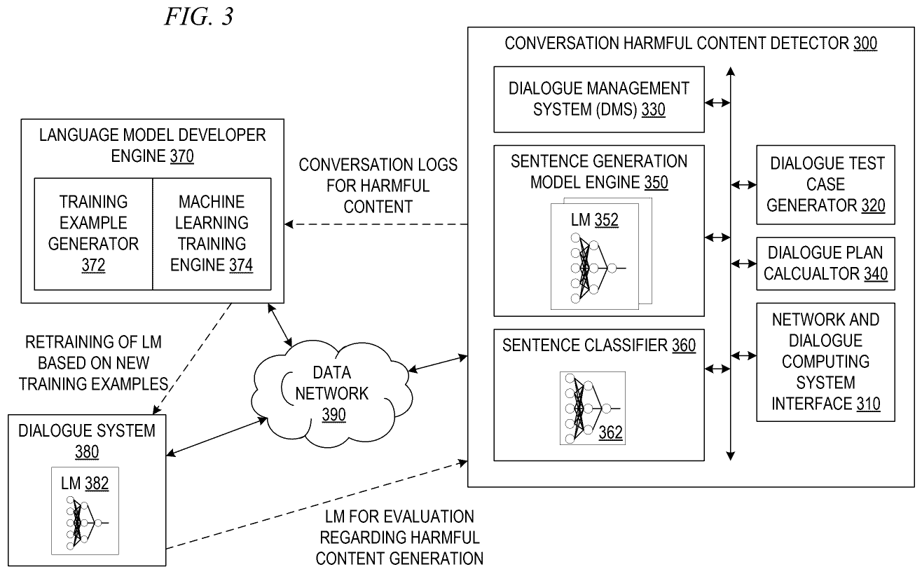

FIG. 3 is an example diagram of components of a conversation harmful content detector in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that dialogue computing systems operate by discovering conversation paths that lead to harmful content being presented, and providing conversation logs to a developer for retraining the language models used to generate responses to user inputs so as to avoid such harmful content. The illustrative embodiments provide a specific computer technology solution that implements a conversation harmful content detector having a dialogue management system, dialogue plan calculator, sentence generation model, and sentence classifier, which cannot be practically performed by human beings as a mental process and is not directed to organizing any human activity.

As shown in FIG. 3, the conversation harmful content detector 300 includes a network and dialogue computing system interface 310, a dialogue test case generator 320, a dialogue management system (DMS) 330, a dialogue plan calculator 340, a sentence generation model engine 350 having one or more language models (LMs) 352, and a sentence classifier 360. The sentence classifier 360 may be a machine learning model that is trained for classification tasks, and specifically classification of an input sentence as to whether it is “harmful” or “not harmful.” The sentence generation model engine 350 may be a machine learning model capable of generating text, such as a causal language model, e.g., decoder-only. The sentence generation model engine 350 is capable of generating one or more sentences that are the most likely completion of a given context, such as a current dialogue history, chat history, or the like. The illustrative embodiments model the DMS 330 and dialogue plan calculator 340 as an AI planning problem that is defined by a finite set of states S, a finite set of actions A, an initial state S0, and a goal state G. The task of the AI planning problem is to find a sequence of actions (a1, . . . , an), also referred to as a plan or policy, that goes from the initial state S0 to the goal state G.

As shown in FIG. 3, in some illustrative embodiments, the conversation harmful content detector 300 may further include a language model developer engine 370 comprising a training example generator 372 and machine learning training engine 374, as discussed hereafter, or the language model developer engine 370 may be provided as a separate entity from the conversation harmful content detector 300 but which operates based on the conversation logs provided by the conversation harmful content detector 300. The conversation harmful content detector 300 operates in conjunction with one or more dialogue computing systems 380 either locally or via one or more data networks 390 using data communications. In some illustrative embodiments, the sentence generation model engine 350 may utilize a generative machine learning model 352, such as a language model (LM) for example, that is local to the conversation harmful content detector 300 or which is remote to the conversation harmful content detector 300, but accessible via the one or more data networks 380.

It will be assumed for purposes of this description that the generative machine learning model 352 is an LM and will be referenced as LM 352, although this is not intended to be limiting on the possible embodiments of the present invention. Moreover, it will be assumed that the LM used by the sentence generation model 350 is a LM 352 that is local to the conversation harmful content detector 300 for illustrative purposes. It will also be assumed that the language model developer engine 370 is remote from the conversation harmful content detector 300. It should be appreciated that this is only an example selected for ease of explanation of some illustrative embodiments of the present invention and is not intended to be limiting on the possible embodiments of the present invention. Many modifications, as will be apparent to those of ordinary skill in the art in view of the present description, may be made to the configuration and grouping/separation of elements of FIG. 3 without departing from the spirit and scope of the present invention.

The conversation harmful content detector 300 may be employed as a check of a dialogue computing system 380, and specifically of the LM(s) used by the dialogue computing system 380 to generate responses to user inputs. The testing, however, is processed by the conversation harmful content detector 300 using its DMS 330 which controls the flow of the conversation via the LM 352 of the sentence generation model 350. The DMS 330 of the conversation harmful content detector 300 may be similar to the DMS used by the dialogue computing system 380, but is specifically configured to generate dialogue plans that are configured to elicit a harmful content based response from the LM 352, as will be described hereafter. That is, the DMS 330 uses dialogue plans that are designed to reach a location in the hierarchy of the dialogue plan where a response from the LM 352 will contain content classified as harmful content, i.e., inappropriate, derogatory, or offensive content.

In some illustrative embodiments, a LM 352 may be loaded into the sentence generation model engine 350 for evaluation, e.g., the LM used by the dialogue computing system 380, or which is a candidate for deployment for use by the dialogue computing system 380, may be loaded into the sentence generation model engine 350 as LM 352. In testing the LM 352, the dialogue test case generator 320 generates test cases for submission to the dialogue computing system 380. The test cases may be generated using another LM 322 which may generate natural language sentences using zero-shot generation, reinforcement learning, prompt engineering, and/or the like. In some illustrative embodiments, the LM 322 and the test case generator 320 may be a Red Teaming Language Model, such as described in Perez et al., “Red Teaming Language Models with Language Models”, arXiv: 2202.03286v 1 [cs. CL] 7 Feb. 2022. In some illustrative embodiments, the LM 322 may be a conditional generator that operates based on actions, e.g., receiving prompts and populating the prompts with test case content, such as a fine-tuned language model, e.g., fine-tuned GPT-3 or T5Bart model. The test cases are processed by the DMS 330 which directs the LM 352 to generate responses to the sentences generated by the LM 322 of the test case generator 320.

The LM 352 processes the test case sentences in accordance with the DMS 330 which may model the dialogue management as a non-deterministic AI planning problem as mentioned above, the solution comprising a state constructed by a set of flags turned on/off depending on the outcome of the dialogue computing system 380 in response to user conversations, a goal state which indicates a subset of flags which need to be on/off, an action of the dialogue computing system 380 which includes predictions and effects as well as which effects lead a successor state in a non-deterministic manner depending on the user response, and each action being mapped to a sentence generator model.

For example, using the previously mentioned travel assistant chatbot (see FIG. 1), a set of actions may be: ask-destination, ask-date-of-travel, ask-number-of-passengers, ask-way-of-travel. A state may be defined by an assignment of values to a set of so-called state variables {x_1, x_2, . . . , x_m}. In this example, the state variables could be x_1—destination, x_2—date-of-travel, x_3—num-passengers, x_4—flight-number, and x_5—expected arrival time. These variables take values in corresponding domains of values. For example, the domain of x_1 could be the set of cities in France that have an airport close by. It can be seen that the number of states can be exponentially large.

One algorithm that can be used for computing a plan or policy for these types of AI planning problems is the Loopy AO* (or LAO*) algorithm. LAO* is a best-first search algorithm that explores the state space. It starts from the root node of the state space which corresponds to the initial state and looks for a path from root to a leaf node which corresponds to a goal state. Each node in the state space corresponds to a partial state (i.e., some of the state-variables are assigned and some variables are not assigned). Furthermore, at each node, the algorithm expands that node and generates its successor nodes by applying the actions to that node. In addition, LAO* computes an evaluation function F(.) for each node which indicates how good the node is. It uses this function F(.) to select the next best node in the state space to expand to next. In some illustrative embodiments, the LAO* algorithm is modified to find plans that are likely to terminate with a harmful expression, as discussed hereafter.

Returning to FIG. 3, the DMS 330 controls the sentence generation by the sentence generation model engine 350 in accordance with one or more dialogue plans implemented by the DMS 330. The dialogue plan calculator 340 learns a policy for use by the DMS 330 that attempts to lead a user to increasing the chance of the dialogue computing system 380 generating a response to the test case that comprises harmful content. The dialogue plan implemented by the DMS 330 is represented as a graph satisfying the condition that any successor node in the graph generated by any action needs to lead to a goal state. Thus, by traversing the graph, one eventually reaches a goal state. The path through the graph is determined by calculating the successor node to select based on the context of the current sentence and the previous context of the conversation (or dialogue).

In one illustrative embodiment, the dialogue plan calculator 340 learns a plan or policy given a sentence classifier 360 and DMS 330 with corresponding dialog plan, by using the previously mentioned modified LAO* process to obtain a minimal value according to an objective function F. That is, the learning of a policy may be modeled as a state-space search in which there are a set of states, a set of actions or operators that map states to successor states, a start state, and a set of goal states. The objective is to find a sequence of actions, i.e., a path or policy through the dialogue plan, that transforms the start state into a goal state and optimizes a measure of the quality of the solution. That is, the dialogue plan calculator 340 may utilize a heuristic search algorithm, such as a LAO*, for a state-space search problem using Markov decision process (MDP) modeling of the problem of sequential decision making that includes actions that transform a state into one of several possible successor states, each possible transition occurring with some probability.

With regard to the illustrative embodiments, the learning of the policy by performing the LAO* algorithm, or other heuristic search algorithm, may seek a minimal value according to the objective function F defined as follows:
F(n)=0 if n is a terminal node of the dialogue plan that has harmful content;
F(n)=1 if n is a terminal node of the dialogue plan that does not have harmful content;
F(n)=min(F(s1), F(s2), . . . , F(sk)), where n is an OR node where s1, . . . , sk are successor states;
F(n)=(F(s1)×p(s1))+ . . . +(F(sk)×p(sk)), where n is an AND node;
p(si) is a probability of reaching a successor state si of state n.
   The LAO* operation with the above objective function F may be initiated when the test case conversation processing is started by the dialogue computing system 380 under direction of the DMS 330. Furthermore, it is assumed that a successor state of an action, such as “ask-destination”, also contains the sentence generated by a sentence generation model (specifically, a state variable x is introduced whose value is the sentence generated for the respective action). In the modified LAO* algorithm of the illustrative embodiments, the function F(n) of the internal node n (i.e., a non-terminal node) is updated recursively based on the F(.) function of its successor nodes.

This operation may be performed with regard to each test case and may result in learned plans or policies that lead each test case to a goal state node that comprises harmful content. The resulting plan or policy is a conversation log comprising a series of the test case natural language inputs and resulting natural language statements generated by the sentence generation model 350 corresponding to the nodes in the dialogue plan. It should be appreciated that such plans or policies may be determined in an offline or online process. In the online case, at every interaction with the dialog manager, a new plan is computed starting from the current state to achieve the goal state. These online plans can be different than the ones computed offline.

In learning the policies based on the dialogue plan, the DMS 330 and dialogue plan calculator 340 determine a successor node through the dialogue plan and then instruct the sentence generation model 350 to generate a corresponding natural language sentence response. The sentences generated by the sentence generation model engine 350 based on the operation of the LM 352 are evaluated by the sentence classifier 360 as to whether the sentence comprises harmful content or not. The sentence classifier 360 may be a neural network computer model or other machine learning computer model, a rules based engine, or the like, which finds instances of terms and phrases that have been predetermined to be potentially harmful content. In some illustrative embodiments, a database of such harmful terms and phrases may be maintained and may be updated by subject matter experts such as to be used by the sentence classifier 360 as to whether or not generated sentences likely contain harmful content. The sentence classifier 360 may operate on word embeddings, vector similarities, and the like, as well as evaluate the context of the identified terms/phrases to make the sentence classifications with regard to whether the sentences contain harmful content or not. If a sentence is determined to have harmful content, it may be flagged as such by the sentence classifier 360 for further processing as described hereafter.

Sentences classified as containing harmful content are used as triggers to generate conversation logs comprising the history of natural language inputs and responses that led to the harmful content. The conversation logs are output to the language model developer engine 370. The language model developer engine 370 generates one or more training examples based on the conversation logs and executes machine learning training by the machine learning training engine 374 on the LM 352 to thereby retrain the LM 352 to avoid the harmful content when responding to the same or similar user inputs. That is, in generating training examples, the conversation logs may operate as context for a prompt input to the LM 352 and the ground truth may be set to a response that does not have harmful content. That is, a subject matter expert may specify an alternative response from the ones having harmful content and associated that alternative response with the new training example. This will cause the LM 352, through the machine learning training engine 374, to learn to generate an alternative response generation when presented with the same or similar context in the future, rather than the response having the harmful content. In some illustrative embodiments, the retraining of the LM 352 may include using a similar Loopy AO* operation as discussed above but with the objective function F modified to promote generation of responses that do not contain harmful content, e.g., the criteria for the objective function above, but with F(n)=1 if n is a terminal node with a harmful expression, and F(n)=0 if n is a terminal node without a harmful expression.

Once retrained in this manner, the LM 352, when presented with a similar context of a conversation, e.g., starting natural language input from a user, will prioritize paths through the dialogue plan that do not result in a harmful content being generated in a response to the user. Thus, rather than resulting in the dialogue 110 in FIG. 1, the LM 352 will generate a dialogue 120. Hence, the mechanisms of the computing tool and computing tool operations of the illustrative embodiments learn policies that lead to harmful content given a dialogue plan and a starting state, e.g., user natural language input, and convert these policies to conversation logs. The conversation logs are used to generate new training examples that are then used to retrain the LM 352 so that it avoids generation of responses with harmful content. The resulting retrained LM 352 may then be returned for deployment into the dialogue computing system 380 for runtime use. As a result, the illustrative embodiments minimize the risk of generating harmful content by effectively identifying and fixing the issues in the LM that cause the LM to generate responses having such harmful content.

Thus, in accordance with one or more illustrative embodiment, an example use-case may be the travel assistant chatbot or conversation system, such as that described above with regard to FIG. 1. Possible actions in this use case may be the previously mentioned “ask-destination” or “ask-number-of-passengers” actions. In addition, in accordance with the illustrative embodiments, an auxiliary (possibly hidden) action may be provided that can instruct the sentence generation model to generate harmful expressions, e.g., “ask-harmful.” This action may be applied with a relatively low probability in each state, or may be applied only in specific states. This can be used to trigger the sentence generation model to generate harmful expressions in a somewhat controlled manner.

With this use-case in mind, a goal is to conduct a series of interactions or conversations with the dialogue manager system (DMS) to collect a dataset that consists of conversations that terminate with harmful expressions, i.e., “bad” conversations. A conversation is essential a sequence of responses, one from the user and one from the agent. The system can also collect “good” conversations that do not terminate with harmful expressions. Therefore, a dataset may be obtained that contains both “harmful” or “bad” conversations, and “good” conversations. This dataset may be used by the mechanisms of the illustrative embodiments to further fine-tune the language model (LM) used for generating sentences to avoid generating harmful content. The generation of such a dataset and the fine-tuning of LMs may be repeated for multiple use-cases, e.g., travel assistant, movie ticket reservation agent, etc. Thus, for example, the components 320, 330, 350, and 360 may operate over multiple use-cases to generate the “harmful”/“good” conversations dataset. Subsequently, components, such as 372 and 374 may be used to fine-tune/retrain the LM used for sentence generation in component 350. The new fine-tuned sentence generation model may then be deployed and components 330, 340, 350, and 380 (with the new model) may be used for a new use-case.

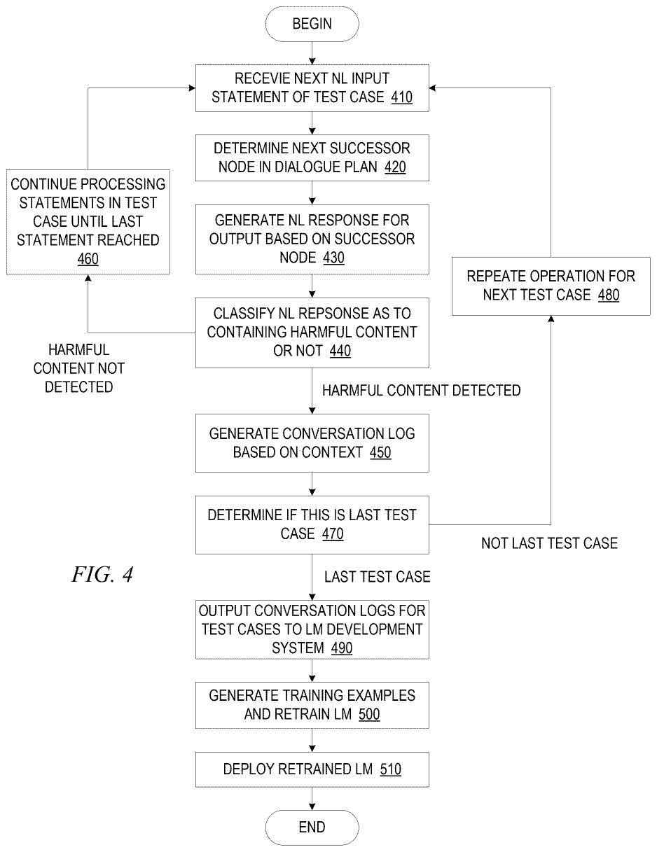

FIG. 4 is a flowchart outlining an example operation of a conversation harmful content detector in accordance with one illustrative embodiment. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

As shown in FIG. 4, the operation starts with the submission of a next natural language input statement of a test case to the dialogue manager system to determine a response to the next input statement of the test case (step 410). The dialogue manager invokes a dialog plan calculator to determine a next successor node of the dialogue plan given the current context of the test case, where the next successor node is determined in accordance with an objective function that maximizes the likelihood of following a path through the dialogue plan that leads to a state associated with harmful content (step 420). Based on the determination of a next successor node in the dialogue plan, the sentence generation model generates a natural language response for output (step 430). The generated natural language sentence is classified as to whether it contains harmful content or not (step 440). In response to the sentence being classified as having harmful content, a conversation log is generated based on the context of the conversation corresponding to the test case (step 450). If the sentence is not classified as having harmful content, then the operation returns to step 410 and continues processing sentences of the test case until a sentence with harmful content is detected or a terminal node in the dialogue plan is reached (step 460).

The operation then determines if this is the last test case (step 470). If not, the operation returns to step 410 for the next test case (step 480). If this is the last test case, then the conversation logs for the test cases are output to a language model development system (step 490). The language model development system generates training examples based on the conversation logs and retrains the language model of the dialogue computing system based on these training examples (step 500). The retrained language model is then deployed for runtime use in the dialogue computing system (step 510). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
inputting a test case, comprising one or more natural language statements, into a dialogue management system (DMS), where the DMS is configured to maximize a probability that processing the test case will result in an output by an artificial intelligence language model (LM) that contains harmful content;
processing, by the LM, the test case to generate a responsive natural language output based on a dialogue plan of the DMS;
analyzing the responsive natural language output to determine if the responsive natural language output comprises harmful content; and
in response to the responsive natural language output being determined to comprise harmful content:
generating a conversation log for the test case based on a context of the test case, wherein the context of the test case comprises a series of natural language inputs of the test case and natural language responses generated by the LM during processing of the test case; and
outputting the conversation log to a language model development computing system for retraining the LM to avoid generation of responses comprising harmful content.

2. The method of claim 1, wherein the harmful content is content that is one of offensive, inappropriate, or derogatory with regard to a user.

3. The method of claim 1, further comprising retraining the LM to avoid generation of responses comprising harmful content at least by generating training examples from the conversation log, wherein the training examples comprise ground truth data modified to not include harmful content.

4. The method of claim 3, wherein retraining the LM further comprises populating user response and context information of one or more training examples from content of the conversation log;
submitting the one or more training examples to the LM to obtain a response;
comparing the response to a ground truth response that the LM should generate that does not include harmful content, to determine a loss; and
modifying at least one operational parameter of the LM to reduce the loss.

5. The method of claim 1, further comprising determining the dialogue plan based on a state-space search algorithm that determines a set of actions to take to progress from a starting state to a goal state corresponding to the harmful content.

6. The method of claim 5, wherein the state-space search algorithm is a modified Loopy AO* algorithm in which the goal state is the harmful content.

7. The method of claim 6, wherein the modified Loopy AO* algorithm implements an objective function F defined as follows:
F(n)=0 if n is a terminal node of the dialogue plan that has the harmful content;
F(n)=1 if n is a terminal node of the dialogue plan that does not have the harmful content;
F(n)=min(F(s1), F(s2), . . . , F(sk)), where n is an OR node and where s1, . . . , sk are successor states;
F(n)=(F(s1)×p(s1))+ . . . +(F(sk)×p(sk)), where n is an AND node; and
p(si) is a probability of reaching a successor state si of state n.

8. The method of claim 1, wherein analyzing the responsive natural language output to determine if the responsive natural language output comprises harmful content comprises:
inputting the responsive natural language output to a trained machine learning classifier computer model that outputs a classification as to whether the responsive natural language output contains the harmful content or not; and
in response to the responsive natural language output being classified as containing harmful content, generating the conversation log from content of a conversation of a dialogue system managed by the DMS.

9. The method of claim 1, wherein the retrained LM prioritizes paths through a dialogue plan that do not result in the harmful content being generated in response to a user input.

10. The method of claim 8, wherein the dialogue system is one of a chat bot or automated assistant conversation system.

11. A computer program product comprising:
one or more computer-readable storage media; and
program instructions stored on the one or more computer-readable storage media to perform operations comprising:
inputting a test case, comprising one or more natural language statements, into a dialogue management system (DMS), where the DMS is configured to maximize a probability that processing the test case will result in an output by an artificial intelligence language model (LM) that contains harmful content;
processing, by the LM, the test case to generate a responsive natural language output based on a dialogue plan of the DMS;
analyzing the responsive natural language output to determine if the responsive natural language output comprises harmful content; and
in response to the responsive natural language output being determined to comprise harmful content:
generating a conversation log for the test case based on a context of the test case, wherein the context of the test case comprises a series of natural language inputs of the test case and natural language responses generated by the LM during processing of the test case; and
outputting the conversation log to a language model development computing system for retraining the LM to avoid generation of responses comprising harmful content.

12. The computer program product of claim 11, wherein the harmful content is content that is one of offensive, inappropriate, or derogatory with regard to a user.

13. The computer program product of claim 11, wherein the operations further comprise retraining the LM to avoid generation of responses comprising harmful content at least by generating training examples from the conversation log, wherein the training examples comprise ground truth data modified to not include harmful content.

14. The computer program product of claim 13, wherein retraining the LM further comprises populating user response and context information of one or more training examples from content of the conversation log;
submitting the one or more training examples to the LM to obtain a response;
comparing the response to a ground truth response that the LM should generate that does not include harmful content, to determine a loss; and
modifying at least one operational parameter of the LM to reduce the loss.

15. The computer program product of claim 11, wherein the operations further comprise determining the dialogue plan based on a state-space search algorithm that determines a set of actions to take to progress from a starting state to a goal state corresponding to the harmful content.

16. The computer program product of claim 15, wherein the state-space search algorithm is a modified Loopy AO* algorithm in which the goal state is the harmful content.

17. The computer program product of claim 16, wherein the modified Loopy AO* algorithm implements an objective function F defined as follows:
F(n)=0 if n is a terminal node of the dialogue plan that has the harmful content;
F(n)=1 if n is a terminal node of the dialogue plan that does not have the harmful content;
F(n)=min(F(s1), F(s2), . . . , F(sk)), where n is an OR node and where s1, . . . , sk are successor states;
F(n)=(F(s1)×p(s1))+ . . . +(F(sk)×p(sk)), where n is an AND node; and
p(si) is a probability of reaching a successor state si of state n.

18. The computer program product of claim 11, wherein analyzing the responsive natural language output to determine if the responsive natural language output comprises harmful content comprises:
inputting the responsive natural language output to a trained machine learning classifier computer model that outputs a classification as to whether the responsive natural language output contains the harmful content or not; and
in response to the responsive natural language output being classified as containing harmful content, generating the conversation log from content of a conversation of a dialogue system managed by the DMS.

19. The computer program product of claim 11, wherein the retrained LM prioritizes paths through a dialogue plan that do not result in the harmful content being generated in response to a user input.

20. A computer system comprising:
a processor set;
one or more computer-readable storage media; and
program instructions stored on the one or more computer-readable storage media to cause the processor set to perform operations comprising:
inputting a test case, comprising one or more natural language statements, into a dialogue management system (DMS), where the DMS is configured to maximize a probability that processing the test case will result in an output by an artificial intelligence language model (LM) that contains harmful content;
processing, by the LM, the test case to generate a responsive natural language output based on a dialogue plan of the DMS;
analyzing the responsive natural language output to determine if the responsive natural language output comprises harmful content; and
in response to the responsive natural language output being determined to comprise harmful content:
generating a conversation log for the test case based on a context of the test case, wherein the context of the test case comprises a series of natural language inputs of the test case and natural language responses generated by the LM during processing of the test case; and
outputting the conversation log to a language model development computing system for retraining the LM to avoid generation of responses comprising harmful content.
